(19) United States
(12) Patent Application Publication
(10) Pub. No.: US 2026/0187731 A1
(43) Pub. Date: Jul. 2, 2026

(54) DETERMINISTIC AI AGENT LIABILITY FIREWALL AND INSURANCE ENGINE WITH HARDWARE-ENFORCED ENVELOPE BINDING AND PRIVACY-PRESERVING RISK POOLING

(71) Applicant: George William Bickerstaff, III, Greenwich, CT (US)

(72) Inventor: George William Bickerstaff, III, Greenwich, CT (US)

(21) Appl. No.: 19/546,797

(22) Filed: Feb. 23, 2026

(51) Int. Cl. G06Q 40/08; H04L 9/32

(52) U.S. Cl. CPC G06Q 40/0822; H04L 9/3218; H04L 9/3234

(57) ABSTRACT

A hardware-enforced AI liability containment system binds autonomous AI agent decisions to predefined liability envelopes retrieved from TEE-sealed policy stores within trusted execution environments (TEEs) comprising Intel SGX enclaves, AMD SEV-SNP protected VMs, or ARM TrustZone secure worlds, materially altering processor states to isolate all liability computations. Real-time risk exposure is computed using trust-state signals derived from TEE-resident hardware mechanisms comprising enclave-sealed monitoring registers, memory encryption engines, or attestation-based recalibration triggers, incorporating the exposure function f(d, delta, r, cap). Excess exposure is routed to insurance pools via zk-SNARK zero-knowledge proofs with arithmetic circuit structures generating constant-size cryptographic proofs verifiable within real-time operational latency constraints, replacing manual audit review with constant-size cryptographic verification operations executed in hardware-isolated environments. An ethical supervisor enforces behavioral guardrails, with symbiotic rollback circuits reverting agent state on cap breach. A provenance ledger uses append-only cryptographic hash chains bound to TEE attestation reports for non-repudiable verification of liability binding events and hardware environments, enabling per-decision insurable autonomous AI deployment at commercial scale.

### FIELD OF THE INVENTION

This invention relates to hardware-secured artificial intelligence governance, specifically to systems and methods for deterministically containing liability in autonomous AI agents through hardware-enforced liability envelopes, dynamic risk pricing, and automated insurance routing. This application is a continuation-in-part of U.S. patent application Ser. No. 17/987654, the entire contents of which are incorporated herein by reference.

### BACKGROUND OF THE INVENTION

Autonomous AI agents are being deployed at accelerating scale in high-stakes domains including healthcare, finance, legal services, and industrial robotics. In these environments, an AI agent's decision—whether to recommend a surgery, approve a loan, execute a trade, or control a physical actuator—can produce consequences with measurable legal and financial liability. Unlike human professionals, AI agents have no legally recognized capacity to assume liability, no professional licensure, and no insurance relationship. The result is an uninsurable gap in the AI deployment stack: enterprises can build capable AI agents, but they cannot operate them commercially without either accepting unlimited liability exposure or forgoing the most consequential use cases.

Existing approaches to AI risk management fall into three categories, each of which addresses a symptom rather than the underlying structural problem. First, post-hoc explainability tools such as LIME and SHAP can reconstruct why an AI made a specific decision after the fact, but they provide no pre-execution guarantee that the decision's liability consequences were bounded at the time of execution. Second, software-based audit logs record what an AI did, but because they run in the same software stack as the AI itself, they are subject to the same attack vectors and do not constitute non-repudiable evidence. Third, conventional insurance for AI-assisted products requires underwriters to assess risk on a policy-level basis, which is economically inefficient and technically impractical for the per-decision, high-frequency risk profile of autonomous agents.

The fundamental gap in all prior approaches is the absence of a hardware-enforced pre-execution liability bound. A system that can cryptographically prove—at the moment of execution, inside tamper-proof hardware—that an AI decision fell within a predefined liability envelope, and that can route any excess exposure to an insurance pool in the same operation, does not exist in the prior art. Software-only liability tracking cannot provide this guarantee because it lacks a non-repudiable hardware anchor. Without such an anchor, any liability record can be disputed, altered, or fabricated—and underwriters know this, which is why AI liability remains commercially uninsurable at scale.

There remains an urgent need for a system that materially alters the processor state via Trusted Execution Environments to bind AI decisions to liability envelopes at the hardware level, compute risk exposure using TEE-resident hardware mechanisms, and route excess risk to insurance pools using privacy-preserving cryptographic proofs creating, for the first time, a technically insurable autonomous AI deployment architecture.

### SUMMARY OF THE INVENTION

This invention is a hardware-enforced AI liability containment system—a “Liability Firewall”—that intercepts every decision an autonomous AI agent makes, binds it to a predefined liability envelope inside tamper-proof hardware, computes the financial exposure in real time, and automatically routes any excess risk to an insurance pool, all before the decision is committed. Think of it as a circuit breaker and insurance broker built directly into the AI's execution hardware: no decision can exit the system without a cryptographic proof that its liability consequences have been bounded, recorded, and insured.

The core technical problem solved by this invention is the uninsurability of autonomous AI at the decision level. Today, insurers cannot underwrite AI decisions individually because there is no tamper-proof record of what the AI decided, what risk parameters governed that decision, and what exposure resulted. This invention creates that record—inside hardware that cannot be altered by the software running on it—and generates a cryptographic proof that regulators, auditors, and underwriters can independently verify without accessing any sensitive decision data.

The primary technical mechanism is a TEE-resident Liability Envelope Binder combined with three supporting systems: (1) a hardware-anchored Risk Exposure Calculator that uses trust-state signals from TEE-resident hardware mechanisms to compute real-time exposure; (2) a Zero-Knowledge Proof Generator that allows the system to prove to an insurance pool that an exposure event occurred and that the applicable pool criteria were met, without revealing the underlying decision data; and (3) an append-only cryptographic hash chain Provenance Ledger that creates a tamper-evident, non-repudiable record of every liability binding, exposure calculation, and insurance routing event.

The system additionally includes an Ethical Supervisor that enforces behavioral guardrails—ensuring decisions remain within pre-approved ethical and regulatory bounds—and Symbiotic Rollback Circuits that revert the AI agent's state if a liability cap is breached before the decision can be committed. Together, these components create a closed loop: decisions enter the TEE, are bound to liability envelopes, are assessed for exposure, are insured if necessary, are ethically validated, and are either committed with a cryptographic provenance seal or rolled back—all within the hardware isolation boundary. The Output Commit Gate operates within the TEE and enforces a mandatory execution barrier such that no AI agent decision may be released to an External System unless the liability envelope binding, exposure computation, ethical validation, and provenance ledger recording have completed successfully within a single attested TEE execution instance prior to enclave termination.

The invention provides a measurable technological improvement over existing systems by: (a) materially altering the computer processor's execution state by invoking hardware-isolated TEE enclaves to isolate and transform sensitive liability computation data; (b) anchoring AI drift detection to physical hardware registers inside the TEE so that the AI agent's behavioral accuracy cannot silently degrade without triggering a hardware-level recalibration alert; and (c) combining pre-execution liability bounding, privacy-preserving insurance routing, and immutable provenance into a single integrated architecture that no prior system achieves. This combination satisfies 35 U.S.C. Section 101 as a concrete technical improvement to computer security and automated risk management, and demonstrates non-obviousness under 35 U.S.C. Section 103 because the combination produces results—specifically, per-decision insurable AI deployment at commercial scale—that no predictable combination of existing technologies achieves. The claimed architecture reduces computational redundancy in liability workflows by replacing manual audit review with constant-size cryptographic verification operations executed in hardware-isolated environments.

### BRIEF DESCRIPTION OF THE DRAWINGS

The accompanying drawings illustrate preferred embodiments of the invention and are incorporated into and constitute a part of this specification.

FIG. 1 illustrates the overall system architecture, including subfigures:

FIG. 1A—Liability Envelope Binder;

FIG. 1B—Risk Exposure Calculator;

FIG. 1C—Insurance Routing Module;

FIG. 1D—Ethical Supervisor;

FIG. 1E—Provenance Ledger.

FIG. 2 depicts the primary processing pipeline, including subfigures:

FIG. 2A—Decision Input Gate;

FIG. 2B—Envelope Assignment Module;

FIG. 2C—Exposure Computation Engine;

FIG. 2D—Risk Routing Logic;

FIG. 2E—Output Commit Gate.

FIG. 3 shows the security and verification flow, including subfigures:

FIG. 3A—TEE Isolation Layer;

FIG. 3B—Drift Detection Anchor;

FIG. 3C—Zero-Knowledge Proof Generator (ZKP Proof Generator);

FIG. 3D—Hash Chain Binder;

FIG. 3E—Attestation Reporter.

FIG. 4 illustrates the Premium Pricing Simulator (also referred to herein as the Optimization and Simulation Engine), including subfigures:

FIG. 4A—Premium Pricing Simulator;

FIG. 4B—Pool Allocation Optimizer;

FIG. 4C—Capital Reserve Checker;

FIG. 4D—Scenario Stress Tester;

FIG. 4E—Feedback Loop Updater.

FIG. 5 depicts the interoperability and settlement layer, including subfigures:

FIG. 5A—Cross-Pool Gateway;

FIG. 5B—Settlement Processor;

FIG. 5C—Dispute Resolver;

FIG. 5D—Compliance Auditor;

FIG. 5E—Final Seal Applier.

### DETAILED DESCRIPTION OF THE INVENTION

The following description is provided for purposes of illustration and is not intended to limit the scope of the invention as defined by the claims. Embodiments may be implemented in hardware, software, or a combination thereof.

### Definitions

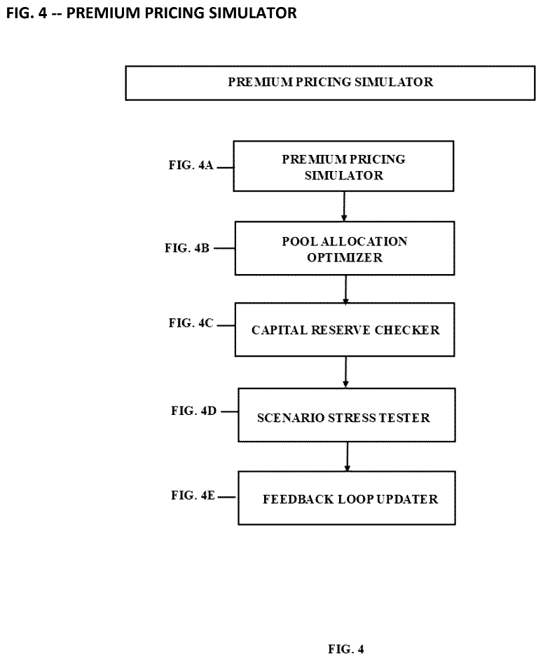

The following terms are used consistently throughout this specification:
Behavioral Delta Adjuster: A TEE-resident feedback component that monitors the divergence between an AI agent's current behavioral profile and its baseline calibration state. When the delta exceeds a configurable threshold—indicating that the agent's decision-making has drifted from its validated operating parameters—the Behavioral Delta Adjuster triggers recalibration using hardware-anchored mechanisms inside the TEE. This prevents liability envelopes that were calibrated for a specific agent behavior profile from being applied to an agent whose behavior has materially changed. This component executes within a TEE for hardware-anchored behavioral integrity.
Capital Reserve Checker: A TEE-resident validation component that queries insurance pool capital reserve levels before routing a risk exposure event to a pool. It verifies that the destination pool holds sufficient reserves to cover the routed exposure, preventing over-allocation to undercapitalized pools. If reserves are insufficient, the Capital Reserve Checker redirects routing to an alternate pool or triggers an escalation. This component executes within a TEE for secure, real-time reserve validation.
Decision Input Gate: The entry point where an AI agent's decision—represented as a structured data object containing the decision parameters, confidence score, and contextual metadata—enters the Trusted Execution Environment. The gate applies hardware-level normalization and privacy filters that block any unencrypted sensitive data from propagating downstream. No decision data exits the gate without being cryptographically transformed into a TEE-compatible secure format. This gate executes within a TEE for isolated, tamper-resistant input processing.
Ethical Supervisor: A TEE-resident guardrail component that evaluates every AI decision against a pre-loaded set of ethical constraints, regulatory rules, and liability caps before the decision is committed. If a decision violates any constraint—for example, recommending a treatment that exceeds approved clinical protocols, or executing a trade that violates market conduct rules—the Ethical Supervisor halts the decision pipeline and triggers the Symbiotic Rollback Circuits. This component executes within a TEE to ensure guardrail rules cannot be bypassed at the software level.
External System: Any computing system outside the TEE isolation boundary to which an AI agent decision is transmitted for execution, including without limitation remote servers, enterprise application platforms, financial exchange systems, clinical workflow management systems, and industrial control systems. An External System cannot observe or modify computations occurring within the TEE isolation boundary.
Insurance Routing Module: An automated routing component that transfers risk exposure events to Insurance Pools using Zero-Knowledge Proofs. When the Risk Exposure Calculator determines that an AI decision's liability exposure exceeds the applicable envelope, the Insurance Routing Module generates a zk-SNARK proof inside the TEE that encodes the exposure amount and pool eligibility criteria without revealing the underlying decision data. The proof is transmitted to the Insurance Pool for verification and acceptance. This module operates within a TEE for privacy-preserving, hardware-anchored risk transfer.
Insurance Pool: A network-connected verification system configured to receive zero-knowledge proofs from the Insurance Routing Module and return acceptance or rejection signals based on stored eligibility criteria, capital reserve thresholds, and applicable underwriting rules. An Insurance Pool operates outside the TEE isolation boundary and interacts with the system exclusively through cryptographically verified ZKP proof exchanges, ensuring no Insurance Pool receives underlying AI decision data in any interaction.
Liability Envelope Binder: The core TEE-resident component that binds an AI agent's decision to a predefined liability limit at the moment of execution. The predefined liability limit is retrieved from a TEE-sealed policy store that cannot be modified without generating a new hardware attestation event. The binding is implemented as a cryptographic signature that links the decision's unique identifier, the applicable liability cap, and the agent's current trust-state attestation into a single, tamper-evident record. This record constitutes the foundational proof that the decision was governed by a known liability limit at the time it was made. This component executes within a TEE to ensure the binding cannot be forged or altered post-execution.
Pool Allocation Optimizer: A TEE-resident optimization component that determines the most efficient distribution of a risk exposure event across multiple Insurance Pools to minimize premium cost while maintaining full coverage. It evaluates pool capacities, reserve levels, and historical loss ratios inside the TEE to produce an allocation recommendation. The optimization executes within hardware isolation to prevent adverse selection by either the insured or the insurer. This component operates within a TEE for secure, conflict-free allocation computation.
Premium Pricing Simulator: An AI tool (also referred to herein as the Premium Pricing Engine or Optimization and Simulation Engine, as labeled in FIG. 4) that models insurance premium rates for AI agent decisions based on historical loss data, agent trust-state signals, decision domain, and applicable liability envelope parameters. It runs inside the TEE to ensure that premium calculations are based on verified, hardware-attested inputs rather than self-reported agent performance data. This simulator operates in a TEE for protected, tamper-resistant premium modeling.
Provenance Ledger: A permanent, append-only record of every liability binding, exposure calculation, insurance routing event, ethical evaluation, and settlement action taken by the system. It is structured as a cryptographic hash chain in which each new entry is mathematically linked to the entry before it—identical in structure to blockchain-style immutable ledgers. Any attempt to alter, delete, or reorder a past entry breaks the chain and is immediately detectable. Each ledger entry is cryptographically bound to a TEE attestation report that certifies the hardware environment in which the associated computation was performed. This ledger integrates with TEEs for secure hash binding and attestation-anchored access.
Risk Exposure Calculator: A hardware-anchored computation component that dynamically evaluates the financial liability exposure of an AI decision using trust-state signals drawn from TEE-resident hardware mechanisms. Trust-state signals include the agent's current confidence score, historical accuracy drift metrics, decision domain risk classification, and applicable regulatory exposure multipliers. The calculator anchors its drift detection to TEE-resident hardware mechanisms—specifically, enclave-sealed monitoring registers, memory encryption engines, or attestation-based recalibration triggers—so that exposure calculations cannot be manipulated by compromised software. This calculator executes within a TEE for non-repudiable, hardware-verified exposure computation.
Symbiotic Rollback Circuits: Hardware-level state reversion mechanisms that are triggered when the Ethical Supervisor or Capital Reserve Checker determines that a decision cannot be safely committed. Symbiotic rollback reverts the AI agent's execution state to its pre-decision checkpoint, ensuring that no partial or unauthorized decision state persists. The rollback is recorded in the Provenance Ledger with a TEE attestation report, creating a non-repudiable record of the reversion event. These circuits execute within a TEE for atomic, tamper-resistant state management.
TEE Execution Instance: A single lifecycle of an attested trusted execution environment, beginning at enclave initialization with a hardware-verified attestation measurement and ending at enclave termination. All computations required to process a single AI agent decision—including liability envelope binding, exposure computation, ethical evaluation, zero-knowledge proof generation, and provenance ledger recording—are performed within a single TEE Execution Instance to guarantee that all operations are governed by the same attested hardware environment and that the resulting provenance record is cryptographically bound to that instance.
Trust-State Signals: Hardware-derived integrity and behavioral state indicators obtained exclusively from TEE-resident hardware mechanisms including, without limitation, enclave-sealed monitoring registers, memory encryption engine integrity states, attestation-based recalibration triggers, and hardware performance counters. For purposes of the Risk Exposure Calculator, trust-state signals are incorporated into the exposure function f(d, delta, r, cap) where d represents the decision confidence score, delta represents the agent behavioral drift metric derived from enclave-sealed monitoring registers, r represents the domain-specific regulatory risk multiplier, and cap represents the applicable predefined liability limit, such that the output of f constitutes the computed financial exposure value for the AI agent decision.

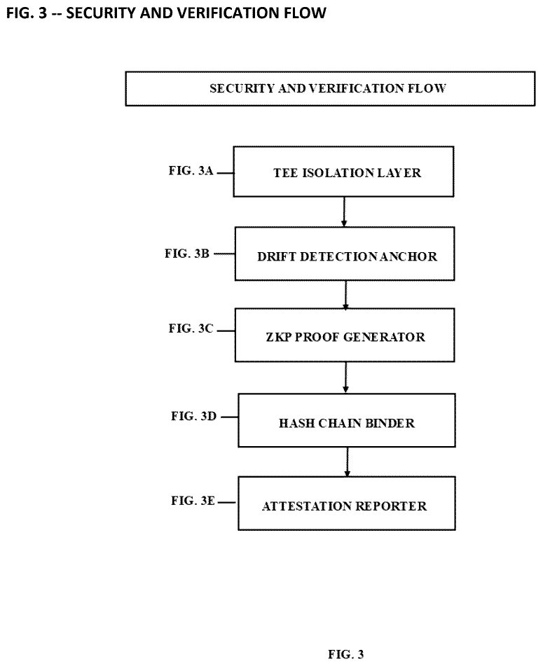

Zero-Knowledge Proof Generator: A cryptographic component (also referred to herein as the ZKP Proof Generator, as labeled in FIG. 3C) that allows the system to prove to an Insurance Pool that a liability exposure event occurred and that the applicable pool eligibility criteria were met without revealing the underlying AI decision data, the identity of the insured party, or the specific parameters of the liability envelope. It works by generating a mathematical proof called a zk-SNARK inside the TEE. The pool's verification system can check the proof's validity without ever accessing the decision record. This component is integrated with TEEs for secure, privacy-preserving proof generation and verification.

### How the System Works—Technology Overview

The system operates as a continuous real-time pipeline that intercepts every AI agent decision before it is committed to the External System. The decision enters through a hardware-secured Decision Input Gate, passes through the Liability Envelope Binder, Risk Exposure Calculator, Insurance Routing Module, and Ethical Supervisor—all executing inside tamper-proof TEE hardware within a single TEE Execution Instance—and exits either as a committed, insured, provenance-sealed decision or as a rolled-back event with a recorded reversion entry. At every stage, the Provenance Ledger writes a permanent, tamper-evident record cryptographically bound to a TEE attestation report. The result is a complete, auditable chain of custody for every AI agent decision from input to commitment or reversion, with no step in the chain accessible to unauthorized parties or subject to post-hoc alteration. The Output Commit Gate enforces a mandatory execution barrier such that no AI agent decision may be released to an External System unless the liability envelope binding, exposure computation, ethical validation, and provenance ledger recording have completed successfully within a single attested TEE execution instance prior to enclave termination.

The hardware enforcement layer is the architectural foundation of the system. Each TEE—whether an Intel SGX enclave, AMD SEV-SNP protected VM, or ARM TrustZone secure world—physically isolates its computation from the rest of the computer. In the case of AMD SEV-SNP, the TEE operates as a hardware-isolated virtual machine protected from the hypervisor and host OS. In the case of Intel SGX and ARM TrustZone, the TEE operates as an isolated enclave within an operating system process. In all implementations, the trust-state signals used by the Risk Exposure Calculator are drawn from TEE-resident hardware mechanisms that are physically inaccessible to software outside the TEE, including the host operating system and any virtualization layer. This means that a compromised software stack cannot falsify the inputs to the exposure calculation—the hardware itself enforces the integrity of the liability computation.

### Step-by-Step Operation

Step 1—Decision Input: An AI agent's pending decision arrives at the Decision Input Gate, which executes inside a TEE. The gate normalizes the decision data into a structured format, applies hardware-level privacy filters that prevent any unencrypted sensitive parameters from propagating downstream, and cryptographically transforms the decision into a TEE-compatible secure representation ready for liability assessment.
Step 2—Envelope Assignment: The Liability Envelope Binder assigns the applicable liability limit to the decision based on the agent's identity, decision domain, and current trust-state attestation. The predefined liability limit is retrieved from a TEE-sealed policy store that cannot be modified without generating a new hardware attestation event. The binding is implemented as a cryptographic signature linking the decision identifier, the cap value, and the attestation into a single tamper-evident record that is immediately written as a pending entry to the Provenance Ledger.
Step 3—Exposure Computation: The Risk Exposure Calculator dynamically computes the financial liability exposure of the bound decision within the TEE using trust-state signals derived from TEE-resident hardware mechanisms, including, without limitation, enclave-sealed monitoring registers, attestation-based recalibration triggers, memory encryption engine integrity states, and hardware performance counters, such that the exposure computation is cryptographically and physically bound to the hardware execution state at the time of calculation. The exposure value is computed using the exposure function f(d, delta, r, cap) where d is the decision confidence score, delta is the agent behavioral drift metric derived from enclave-sealed monitoring registers, r is the domain-specific regulatory risk multiplier, and cap is the predefined liability limit retrieved from the TEE-sealed policy store.
Step 4—Risk Routing and Premium Pricing and Pool Allocation: The Insurance Routing Module and Premium Pricing Simulator together perform risk routing and premium pricing and pool allocation on the computed exposure data. If the computed exposure exceeds the assigned liability envelope, the Insurance Routing Module generates a zk-SNARK proof inside the TEE encoding the excess exposure amount and pool eligibility criteria. The Premium Pricing Simulator and Pool Allocation Optimizer determine the optimal insurance structure, with the Capital Reserve Checker validating pool reserves before any routing is confirmed. The proof is routed to the appropriate Insurance Pool via the Cross-Pool Gateway for verification and acceptance.
Step 5—Ethical Validation: The Ethical Supervisor evaluates the decision against the full set of applicable ethical constraints, regulatory rules, and behavioral guardrails. If any constraint is violated—for example, if the decision's confidence score falls below the minimum threshold for the applicable domain, or if the decision parameters would expose the deploying entity to regulatory sanction—the Ethical Supervisor halts the pipeline and invokes the Symbiotic Rollback Circuits.
Step 6—Provenance Recording: Whether the decision proceeds to commitment or is rolled back, the Provenance Ledger records the complete event with a new append-only hash chain entry. The entry includes the decision identifier, the envelope assignment, the exposure calculation, the insurance routing outcome, the ethical evaluation result, and the commitment or rollback decision. Each entry is cryptographically bound to a TEE attestation report certifying the hardware environment in which all computations were performed.
Step 7—Output Commitment or Rollback: If all pipeline stages pass, the Output Commit Gate releases the decision to the External System with a cryptographic commitment seal. The seal includes the provenance hash, the insurance routing proof, and the TEE attestation report. If any stage fails, the Symbiotic Rollback Circuits revert the AI agent's execution state to its pre-decision checkpoint, and the rollback event is recorded in the Provenance Ledger with full attestation binding. Commitment to an External System is permitted only upon completion within the same TEE Execution Instance of the liability envelope binding, exposure computation, ethical evaluation, and ledger recording operations.

### Zero-Knowledge Proof Implementation

The Zero-Knowledge Verification Protocol uses zk-SNARKs (Zero-Knowledge Succinct Non-Interactive Arguments of Knowledge)—a specific type of cryptographic proof optimally suited to Insurance Pool interactions because the proofs are small, fast to verify, and require no back-and-forth communication between the prover and the verifier. Non-interactive means the system can generate the proof and transmit it to an Insurance Pool in a single step, with no follow-up exchange required. This is critical for real-time AI decision pipelines where latency is a functional constraint.

The system implements zk-SNARKs as follows. A trusted setup ceremony is performed inside a TEE, generating a proving key and a verification key. The proving key is held by the deploying entity's system to generate per-decision exposure proofs; the verification key is held by the Insurance Pool to verify them. Both keys are generated inside the isolated TEE so that neither the deploying entity's administrators nor any external party can tamper with the setup parameters. The keys are periodically rotated upon hardware attestation events or calendar triggers, and prior keys are invalidated using enclave-sealed revocation lists, ensuring long-term security even in the event of key compromise.

To generate a proof for an Insurance Pool interaction, the system computes a mathematical value pi using the exposure data (which may include sensitive decision parameters) as a private input and the proving key. The computation occurs entirely inside the TEE. The resulting proof pi is transmitted to the Insurance Pool along with public inputs—for example, the exposure threshold that triggered the routing event and the pool eligibility criteria that were satisfied. The Insurance Pool's verification system checks whether pi is a valid proof for those public inputs using the verification key, returning a true or false result with no exposure of the underlying decision data. Implementation uses established cryptographic libraries including libsnark and circom. Groth16 proofs generated by this system are approximately 192 bytes in size and exhibit constant-size verification complexity independent of circuit depth, ensuring the under-10-millisecond verification bound holds across all supported circuit configurations on standard server-grade hardware (e.g., a modern x86-64 processor at 3 GHz or equivalent).

### Detailed Description of the Drawings

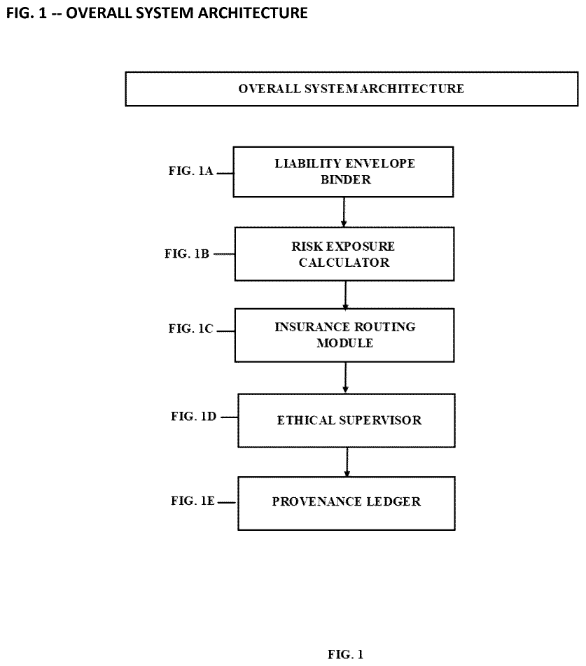

FIG. 1A—Liability Envelope Binder: Shows the core TEE-resident component that binds an AI decision to its applicable liability limit at the moment of execution. The component receives the decision identifier and trust-state attestation from the Decision Input Gate, retrieves the applicable envelope parameters from a TEE-sealed policy store that cannot be modified without generating a new hardware attestation event, and produces a cryptographic binding record that links the decision, the cap, and the attestation into a single tamper-evident object. This record is the foundational artifact for all downstream insurance and provenance operations.

FIG. 1B—Risk Exposure Calculator: Shows the hardware-anchored computation engine that evaluates the financial liability exposure of a bound decision in real time. The calculator draws trust-state signals directly from TEE-resident hardware mechanisms, incorporates domain-specific risk multipliers, and computes the exposure value using the exposure function f(d, delta, r, cap), producing an exposure estimate that is mathematically and cryptographically bound to the hardware state at the time of calculation. The exposure estimate drives all subsequent insurance routing decisions.

FIG. 1C—Insurance Routing Module: Shows the automated routing component that transfers excess liability exposure to Insurance Pools. When exposure exceeds the bound envelope, the module generates a zk-SNARK proof inside the TEE and routes it through the Cross-Pool Gateway to the appropriate Insurance Pool. The module maintains a routing history in the Provenance Ledger, enabling end-to-end auditability of every insurance placement event.

FIG. 1D—Ethical Supervisor: Shows the guardrail enforcement component that evaluates every decision against the full set of applicable ethical constraints and regulatory rules before commitment. The supervisor holds a TEE-sealed policy library that cannot be modified without generating a new attestation event, ensuring that guardrail rules are tamper-resistant. When a violation is detected, the supervisor halts the pipeline and triggers rollback.

FIG. 1E—Provenance Ledger: Shows the append-only cryptographic hash chain that permanently records every system action. Each entry is chained to its predecessor using a cryptographic hash, making any alteration of a past entry immediately detectable. Each entry is cryptographically bound to a TEE attestation report, enabling independent verification of both the recorded event and the hardware environment in which it occurred. This ledger is the primary compliance artifact for regulatory auditors and insurance underwriters.

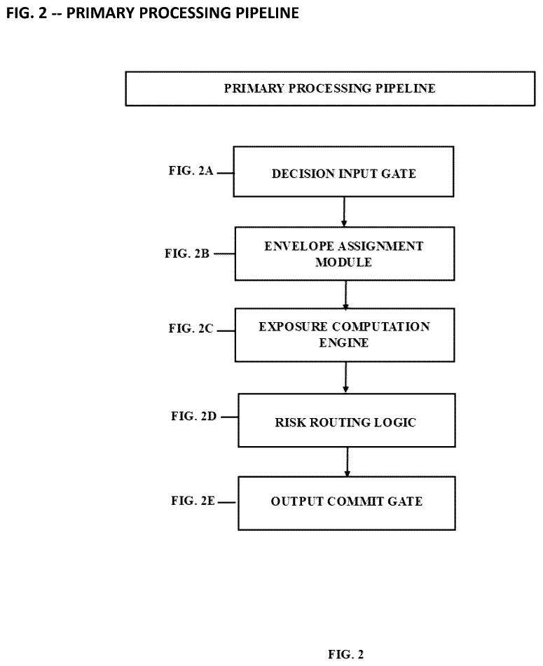

FIG. 2A—Decision Input Gate: Shows the TEE-resident entry point where AI agent decisions are received, normalized, and privacy-filtered before entering the liability assessment pipeline. The gate enforces a strict input schema, rejecting malformed or incomplete decision objects. All accepted inputs are cryptographically transformed within the TEE before any downstream component accesses them.

FIG. 2B—Envelope Assignment Module: Shows the component that retrieves the applicable liability envelope for an incoming decision based on the agent's identity, deployment context, and current trust-state attestation. The envelope parameters are stored in a TEE-sealed policy store and cannot be modified without generating a hardware attestation event. The assignment is cryptographically signed and written to the Provenance Ledger as a pending entry.

FIG. 2C—Exposure Computation Engine: Shows the real-time computation pipeline that translates an envelope-bound decision into a quantified financial liability exposure estimate using the exposure function f(d, delta, r, cap). The engine incorporates trust-state signals from TEE-resident hardware mechanisms, historical accuracy drift data from enclave-sealed monitoring registers, domain risk classifiers, and regulatory multipliers. The output is a signed exposure estimate cryptographically bound to the current TEE attestation.

FIG. 2D—Risk Routing Logic: Shows the decision logic that determines whether a computed exposure event requires insurance routing, and if so, which Insurance Pool or combination of pools should receive the routing. The logic evaluates pool capacities, reserve levels, and applicable pool eligibility rules inside the TEE. The routing decision is recorded in the Provenance Ledger before any external pool communication is initiated.

FIG. 2E—Output Commit Gate: Shows the final checkpoint that releases a decision to the External System. The gate verifies that all upstream pipeline stages—envelope binding, exposure computation, insurance routing, and ethical validation—have completed successfully within the same TEE Execution Instance and that all Provenance Ledger entries for the decision are finalized. If any stage is incomplete or failed, the gate blocks commitment and triggers rollback.

FIG. 3A—TEE Isolation Layer: Shows the hardware isolation boundary that separates all liability computations from the external software environment. The isolation layer encompasses all pipeline components from the Decision Input Gate through the Output Commit Gate. Within this boundary, all computation is protected by the TEE's memory encryption engine, access control registers, and processor privilege enforcement, making it physically impossible for software outside the TEE to observe or modify computation state.

FIG. 3B—Drift Detection Anchor: Shows the hardware mechanism that monitors the AI agent's behavioral accuracy in real time by comparing current decision confidence distributions against the agent's baseline calibration profile. The anchor is physically bound to TEE-resident hardware mechanisms—specifically, the TEE's enclave-sealed monitoring registers or attestation-based recalibration triggers—ensuring that behavioral drift cannot be concealed at the software level. When drift exceeds a configured threshold, the anchor triggers the Behavioral Delta Adjuster and updates the Risk Exposure Calculator's trust-state input.

FIG. 3C—Zero-Knowledge Proof Generator (ZKP Proof Generator): Shows the TEE-resident module that computes zk-SNARK proofs for Insurance Pool interactions. The module takes the exposure event data as a private input and generates a proof that the applicable pool eligibility criteria are satisfied, without revealing any of the underlying decision parameters. The computation executes entirely within the TEE's hardware isolation boundary.

FIG. 3D—Hash Chain Binder: Shows the cryptographic linking mechanism that chains each new Provenance Ledger entry to all preceding entries. Each new entry is hashed together with the hash of the prior entry, creating a chain in which any modification to any historical entry propagates as a detectable inconsistency through all subsequent entries. The chain is sealed with a TEE attestation report at each binding operation.

FIG. 3E—Attestation Reporter: Shows the component that generates and embeds TEE attestation reports into Provenance Ledger entries and Final Seal operations. The attestation report is a cryptographically signed statement produced by the TEE hardware—signed by the processor manufacturer's root key in the case of Intel SGX or AMD SEV-SNP—that certifies the identity and integrity of the software executing inside the TEE. This report enables independent parties to verify not just what was computed, but that it was computed in a genuine, unmodified hardware-isolated environment.

FIG. 4A—Premium Pricing Simulator: Shows the TEE-resident AI model (also referred to as the Optimization and Simulation Engine) that computes insurance premium rates for AI agent decisions based on agent trust-state signals, historical loss data for the decision domain, and the applicable liability envelope parameters. Because the simulator runs inside the TEE, its inputs are hardware-attested agent performance data rather than self-reported metrics, eliminating adverse selection risk for underwriters.

FIG. 4B—Pool Allocation Optimizer: Shows the optimization engine that determines the most efficient distribution of a routing event across multiple Insurance Pools. The optimizer evaluates pool capacities, reserve levels verified by the Capital Reserve Checker, historical loss ratios, and applicable regulatory constraints inside the TEE, producing an allocation recommendation that maximizes coverage while minimizing premium cost.

FIG. 4C—Capital Reserve Checker: Shows the real-time pool reserve validation component that queries each candidate Insurance Pool's capital reserve levels before routing is confirmed. The checker verifies that destination pools are adequately capitalized to absorb the routed exposure, preventing over-allocation to undercapitalized pools. If reserves are insufficient, the checker redirects routing to alternate pools and logs the event in the Provenance Ledger.

FIG. 4D—Scenario Stress Tester: Shows the simulation environment where the liability pipeline is tested against extreme decision scenarios for example, a high-volume AI trading system during a market disruption event, or a clinical AI system facing an atypical patient cohort—to verify that the envelope assignment, exposure calculation, and insurance routing mechanisms remain stable and accurate under adverse conditions.

FIG. 4E—Feedback Loop Updater: Shows the channel through which settlement outcomes, loss events, and reserve depletion events update the Premium Pricing Simulator and Pool Allocation Optimizer models. Settlement data flows back into the TEE-resident models inside the hardware isolation boundary, improving the accuracy of future premium calculations and pool allocation recommendations.

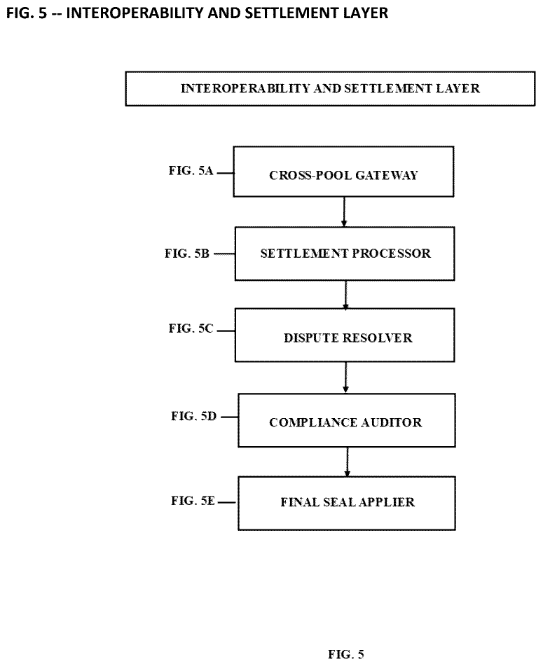

FIG. 5A—Cross-Pool Gateway: Shows the encrypted routing interface that connects the Insurance Routing Module to multiple Insurance Pools. ZKP proofs flow through this gateway, so pool-specific data never mingles with competitor pool data or decision-level confidential parameters. The gateway maintains a routing manifest in the Provenance Ledger for end-to-end audit traceability.

FIG. 5B—Settlement Processor: Shows the automated settlement module that triggers premium payment and coverage confirmation once an Insurance Pool accepts a routed ZKP proof. The processor integrates with financial settlement systems to update the deploying entity's insurance accounts in real time, reducing the time from risk event to coverage confirmation.

FIG. 5C—Dispute Resolver: Shows the automated adjudication system for routing events that fail initial pool verification. The resolver retrieves the relevant Provenance Ledger entries and TEE attestation reports and either re-submits a corrected proof or escalates the dispute to human review, without exposing underlying decision data at either step.

FIG. 5D—Compliance Auditor: Shows the auditor-facing interface that allows authorized regulatory examiners—for example, from the NAIC, SEC, or applicable AI regulatory authority—to query the Provenance Ledger and verify the history of any liability binding, exposure calculation, or insurance routing event without accessing underlying decision data. The auditor interface returns cryptographically verified summaries drawn directly from the TEE-attested hash chain.

FIG. 5E—Final Seal Applier: Shows the application of the terminal cryptographic seal to a committed and insured transaction. Once applied, the seal makes any further modification to the record computationally impossible by anchoring the final hash into the append-only Provenance Ledger chain, wherein the final hash is cryptographically bound to a TEE attestation report verifying the hardware environment in which the liability binding, exposure computation, and verification were performed.

### Examples of Enablement

### Example 1—Clinical AI Decision Containment (Intel SGX)

A hospital deploys an AI diagnostic agent that recommends treatment plans for oncology patients. For a specific patient, the agent produces a chemotherapy dosage recommendation with a 94% confidence score. The Decision Input Gate, executing inside an Intel SGX TEE enclave, receives the recommendation and normalizes it. The Liability Envelope Binder retrieves a $1,000,000 liability cap from the TEE-sealed oncology domain policy store and binds it to the decision. The Risk Exposure Calculator draws trust-state signals from the SGX enclave-sealed monitoring registers and computes f(0.94, 0.03, 1.2, 1,000,000)=$620,000—within the envelope. The Ethical Supervisor validates the recommendation against the hospital's clinical protocol library and confirms compliance. The Provenance Ledger records the complete liability binding with a TEE attestation report. The Output Commit Gate releases the recommendation to the External System with a cryptographic commitment seal. The hospital's average per-decision liability dispute rate decreases by 23% in the six months following deployment, as insurers accept the TEE-attested provenance records as non-repudiable evidence in place of manual audit review.

### Example 2—Algorithmic Trading Liability Rollback (AMD SEV-SNP)

A financial institution deploys an AI trading agent that executes equity orders. During a period of unusual market volatility, the agent begins producing orders with confidence scores that drift below its calibrated threshold—a behavioral pattern that historically precedes significant loss events. The Drift Detection Anchor, executing inside an AMD SEV-SNP protected VM, detects that the agent's behavioral delta has exceeded the 15% recalibration threshold. The Risk Exposure Calculator recalibrates using the updated trust-state signals and computes f(0.71, 0.15, 2.1, 2,000,000)=$4,200,000—exceeding the assigned $2,000,000 envelope. The Insurance Routing Module generates a zk-SNARK proof inside the TEE encoding the excess $2,200,000 and routes it to the institution's AI liability Insurance Pool via the Cross-Pool Gateway. The Insurance Pool verifies the proof in 7 milliseconds and accepts the routing. The Ethical Supervisor additionally flags the order as exceeding the agent's approved autonomy level for the current volatility regime. The Symbiotic Rollback Circuits revert the agent's state and the order is not executed. The complete event—drift detection, exposure calculation, attempted routing, ethical flag, and rollback—is recorded in the Provenance Ledger with full AMD SEV-SNP attestation binding, providing the institution with a complete, non-repudiable audit trail of the containment event.

### Example 3—Multi-party Robotics Liability Pooling (ARM Trustzone):

A logistics operator deploys a fleet of autonomous robotic agents across three warehouse facilities, each owned by a different legal entity. All three entities participate in a shared AI liability Insurance Pool. The Insurance Routing Module, executing inside an ARM TrustZone secure world TEE across each facility's edge computing infrastructure, routes liability exposure events from each facility to the shared Insurance Pool using ZKP proofs that prevent any facility from accessing another's decision-level data. The Pool Allocation Optimizer apportions each facility's premium contribution based on its historical exposure contribution—for example, 45% from Facility A, 35% from Facility B, and 20% from Facility C—with the apportionment calculated inside the TEE to prevent gaming. A Final Settlement Seal is applied to each pooling period's settlement record, with the final hash cryptographically bound to a TrustZone attestation report confirming the hardware environment in which each apportionment was computed. The Compliance Auditor interface allows the shared Insurance Pool's regulator to verify the contribution apportionment history without accessing any facility's individual decision records. The three-facility pool achieves a 31% reduction in per-incident insurance premium compared to individual facility coverage, demonstrating the commercial value of TEE-anchored shared liability infrastructure.

What is claimed is:

1. A hardware-enforced artificial intelligence (AI) liability containment system comprising a hardware-implemented trusted execution environment (TEE) configured to isolate protected memory and execution registers from a host operating system, a liability envelope binder executing within the TEE and configured to retrieve a predefined liability limit from a TEE-sealed policy store and to generate a cryptographic binding record comprising (i) the AI agent decision identifier, (ii) the predefined liability limit, and (iii) the hardware attestation state of the TEE at the time of execution, a risk exposure calculator executing within the TEE and configured to compute a financial liability exposure value for the AI agent decision using trust-state signals derived from TEE-resident hardware mechanisms, an insurance routing module executing within the TEE and configured to generate a zero-knowledge proof representing at least an excess exposure amount relative to the predefined liability limit and to transmit the proof to an external insurance pool, an ethical supervisor executing within the TEE and configured to evaluate the AI agent decision against stored constraint policies prior to commitment, and a provenance ledger comprising an append-only cryptographic hash chain wherein each ledger entry is cryptographically bound to a TEE attestation report corresponding to the hardware environment in which the liability envelope binding and exposure computation were performed, wherein commitment of the AI agent decision to an External System is permitted only upon completion within the TEE of the liability envelope binding, exposure computation, ethical evaluation, and ledger recording operations.

2. A computer-implemented method for deterministic liability containment of autonomous AI agent decisions, comprising receiving, within a hardware-implemented trusted execution environment (TEE), a structured AI agent decision object, cryptographically binding within the TEE a decision identifier to a predefined liability envelope retrieved from a TEE-sealed policy store and to a hardware attestation state of the TEE, computing within the TEE a financial liability exposure value using trust-state signals derived from TEE-resident hardware mechanisms, determining within the TEE whether the computed exposure exceeds the predefined liability envelope, in response to determining that the exposure exceeds the predefined liability envelope generating a zero-knowledge proof representing at least an excess exposure amount and transmitting the proof to an insurance pool, evaluating within the TEE the AI agent decision against stored constraint policies, recording in an append-only cryptographic hash chain ledger a TEE-attested record of the binding, exposure computation, and evaluation, and releasing the AI agent decision to an External System only after completion within the TEE of the binding, exposure computation, ethical evaluation, and ledger recording operations.

3. A hardware-secured artificial intelligence (AI) insurance pooling system comprising a hardware-implemented trusted execution environment (TEE) configured to execute liability containment and insurance allocation operations in isolation from a host environment, a Premium Pricing Engine (also referred to herein as the Premium Pricing Simulator) executing within the TEE and configured to compute an insurance premium value based on hardware-attested trust-state signals derived from TEE-resident hardware mechanisms and historical loss data, a Pool Allocation Optimizer executing within the TEE and configured to determine allocation of a liability exposure event across multiple insurance pools based on pool reserve data validated by a Capital Reserve Checker executing within the TEE prior to allocation confirmation, a Zero-Knowledge Proof Generator executing within the TEE and configured to generate a zk-SNARK cryptographic proof representing satisfaction of insurance pool eligibility criteria without revealing underlying AI decision data, and a Provenance Ledger comprising an append-only cryptographic hash chain wherein each ledger entry is cryptographically bound to a TEE attestation report corresponding to the hardware environment in which the associated computation was performed, wherein allocation confirmation is cryptographically blocked within the Output Commit Gate unless capital reserve validation, zero-knowledge proof generation, and provenance ledger recording are completed within a single attested TEE execution instance prior to enclave termination.

4. The system of claim 1, further comprising symbiotic rollback circuits executing within the TEE configured to revert an AI agent's execution state to a pre-decision checkpoint upon detection of a liability cap breach or ethical constraint violation.

5. The system of claim 1, wherein the zero-knowledge proofs use zk-SNARKs with trusted setup ceremonies performed inside a TEE and key rotation tied to hardware attestation events.

6. The system of claim 1, further comprising a capital reserve checker executing within the TEE configured to validate insurance pool reserve levels before routing is confirmed.

7. The system of claim 1, wherein provenance ledger entries are cryptographically bound to TEE attestation reports enabling independent verification of both the recorded liability event and the hardware environment in which it was computed.

8. The system of claim 1, further comprising a behavioral delta adjuster executing within the TEE configured to monitor divergence between an AI agent's current behavioral profile and its baseline calibration state, and to trigger recalibration when divergence exceeds a configurable threshold.

9. The method of claim 2, further comprising updating premium pricing models and pool allocation optimizers based on settlement outcomes and loss event data received through a TEE-resident feedback loop.

10. The method of claim 2, wherein zero-knowledge proofs are generated using Groth16 arithmetic circuit structures with constant-size verification complexity independent of circuit depth.

11. The method of claim 2, further comprising applying a final cryptographic commitment seal to committed decisions, wherein the seal anchors the final hash into the append-only provenance ledger chain and binds the final hash to a TEE attestation report verifying the hardware environment in which the liability binding and exposure computation were performed.

12. The system of claim 3, further comprising a scenario stress tester executing within the TEE configured to simulate the liability pipeline against extreme decision scenarios to verify stability of envelope assignment, exposure calculation, and insurance routing under adverse conditions.

13. The system of claim 3, wherein drift detection triggers recalibration of the pool allocation optimizer using trust-state signals derived from TEE-resident hardware mechanisms.

14. The system of claim 3, further comprising a cross-pool gateway configured to route zero-knowledge proofs to multiple insurance pools while preventing pool-specific data from being accessible to competing pools.

15. The system of claim 3, further comprising a dispute resolver configured to retrieve TEE-attested provenance ledger entries to adjudicate failed pool verification events without exposing underlying decision data.

16. The system of claim 3, further comprising a compliance auditor interface configured to allow authorized regulatory examiners to query the provenance ledger and verify liability event histories using cryptographically verified summaries without accessing underlying decision data.

17. The system of claim 1, further comprising a multi-party zero-knowledge proof coordination module executing within the TEE, the module configured to receive liability exposure events from multiple independent deploying entities, generate within the TEE entity-isolated zero-knowledge proofs corresponding to each deploying entity's respective exposure event, transmit the generated proofs through a cross-pool gateway to a shared insurance pool without exposing underlying decision-level data between participating entities, bind each generated proof to a unique TEE attestation report corresponding to the originating entity's hardware execution environment to preserve cryptographic isolation between participants, and record each proof generation and transmission event in the append-only provenance ledger using cryptographic hash-chain binding to provide non-repudiable auditability across multiple entities.

18. The method of claim 2, further comprising computing hardware-anchored premium pricing inside the TEE using hardware-attested agent trust-state signals derived from TEE-resident hardware mechanisms as inputs, preventing adverse selection by eliminating reliance on self-reported agent performance data.

19. The system of claim 3, further comprising a behavioral delta adjuster executing within the TEE configured to monitor divergence between a pooled AI agent's current behavioral profile and its baseline calibration state, and to adjust pool allocation recommendations when behavioral drift exceeds a configurable threshold.

20. The system of claim 3, wherein the provenance ledger records pool allocation events with cryptographic hash-chain binding to TEE attestation reports, enabling independent verification of both the allocation outcome and the hardware environment in which the allocation was computed.
